(19) United States
(12) Patent Application Publication
(10) Pub. No.: US 2004/0065659 A1
(43) Pub. Date: Apr. 8, 2004

(54) Heating pad

(75) Inventor: Tung Hoi Tse, Wanchai (HK)

Correspondence Address: LEYDIG VOIT & MAYER, LTD, 700 THIRTEENTH ST. NW, SUITE 300, WASHINGTON, DC, 20005-3960, US

(73) Assignee: Heat Station International Co. Ltd., Wanchai (HK)

(21) Appl. No.: 10/263,089

(22) Filed: Oct. 3, 2002

(51) Int. Cl. H05B 3/34

(52) U.S. Cl. 219/529; 219/549

(57) ABSTRACT

A heating pad includes a multi-filament carbon fibre heating element, or a flat carbon film heating element, and a pair of sheets adhered to one another with the heating element held in position therebetween by the sheets. The heating element is configured in a serpentine form.

### BACKGROUND OF THE INVENTION

The present invention relates to heating pads. More particularly, although not exclusively, the invention relates to a flexible heating pad having a soft multi-filament carbon fibre heating element, or a flat carbon film heating element.

Electric blankets, heating pads for the elderly, in-built electric heating for car seats and the like use hard, metallic conductors. Electric blankets for example have copper conductors that are twisted around one another and sheathed in a plastics or other insulative coating. When lying upon such an electric blanket, one can experience discomfort from such conductors, even through a sheet and possibly an under-blanket, as the conductors are thick and hard.

The same can be said for smaller electric heating pads as might be used for physiotherapy, by arthritic patients and the elderly.

### OBJECTS OF THE INVENTION

It is an object of the present invention to overcome or substantially ameliorate the above disadvantage and/or more generally to provide an improved electric heating pad having a soft, flexible heating element.

It is a further object of the present invention to provide an electric heating pad having a multi-filament carbon fibre, or flat carbon film heating element.

It is a further object of the present invention to provide an electric heating pad having a heating element laminated between a pair of sheets.

It is yet a further object of the present invention to provide a method of manufacturing an electric heating pad having a soft multi-filament, or flat carbon film heating element.

### DISCLOSURE OF THE INVENTION

There is disclosed herein a heating pad comprising:

a multi-filament carbon fibre heating element, or a flat carbon film heating element, and

a pair of sheets adhered to one another with the heating element held in position therebetween by the sheets.

Preferably be heating element is configured in a serpentine form.

Preferably each end of the heating element is attached to a lead wire by a crimp plate.

Preferably the heating pad has a soft padding layer at each side.

Preferably the soft padding layer is covered with an outer-layer.

Preferably, where a multi-filament heating element is employed, the filaments extent substantially parallel to one another without twisting.

There is further disclosed herein a method of manufacturing a heating pad, the method comprising:

providing a jig having a pair of opposed arms each with an array of lugs,

extending a non-insulated carbon heating element back and forth between the arms and once-engaging each lug in a serpentine form,

applying a pair of insulative sheets to each side of the element so as to encase a substantial portion thereof,

adhering the sheets to one another so as to permanently locate the heating element therebetween, and

removing the sheets and elements from the jig.

Preferably, the method further comprises:

crimping a metallic-conductor lead wire to each respective end of the heating element, and

adhering the remaining portions of the sheets to one another to thereby encase the ends of the element therebetween.

Preferably the heating element is a multi-fibre, non-twisted element.

Alternatively, the heating element is a flat carbon film.

### BRIEF DESCRIPTION OF THE DRAWINGS

A preferred form of the present invention will now be described by way of example with reference to the accompanying drawings, wherein:

FIG. 1 is a schematic plan view of a heating pad, and

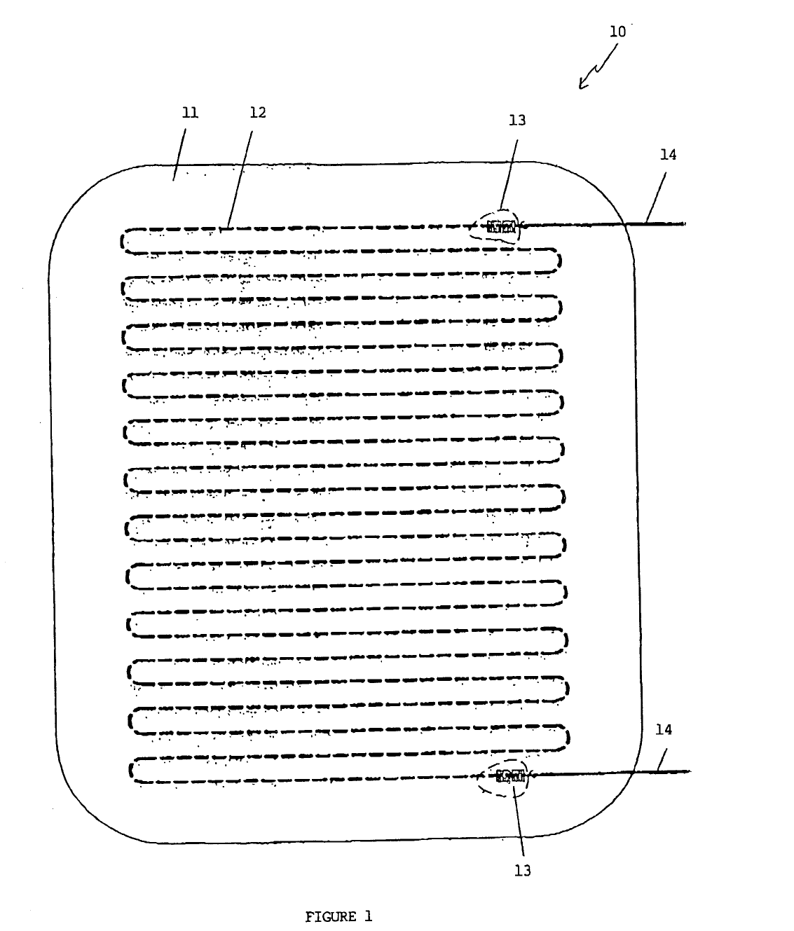

FIG. 2 is a schematic plan view of a heating element supported by a jig.

### DESCRIPTION OF THE PREFERRED EMBODIMENT

In the accompanying drawings there is schematically depicted a heating pad 10. He heating pad 10 comprises a pair of plastics sheets 11 laminated together with a multi-filament carbon fibre heating element 12 fixed therebetween. The heating element 12 is in a serpentine form and has affixed to its respective ends one of a pair of metallic-conductor insulated lead wires 14. Each lead wire 14 is connected to the respective ends of the heating element 12 by a metallic crimp plate 13.

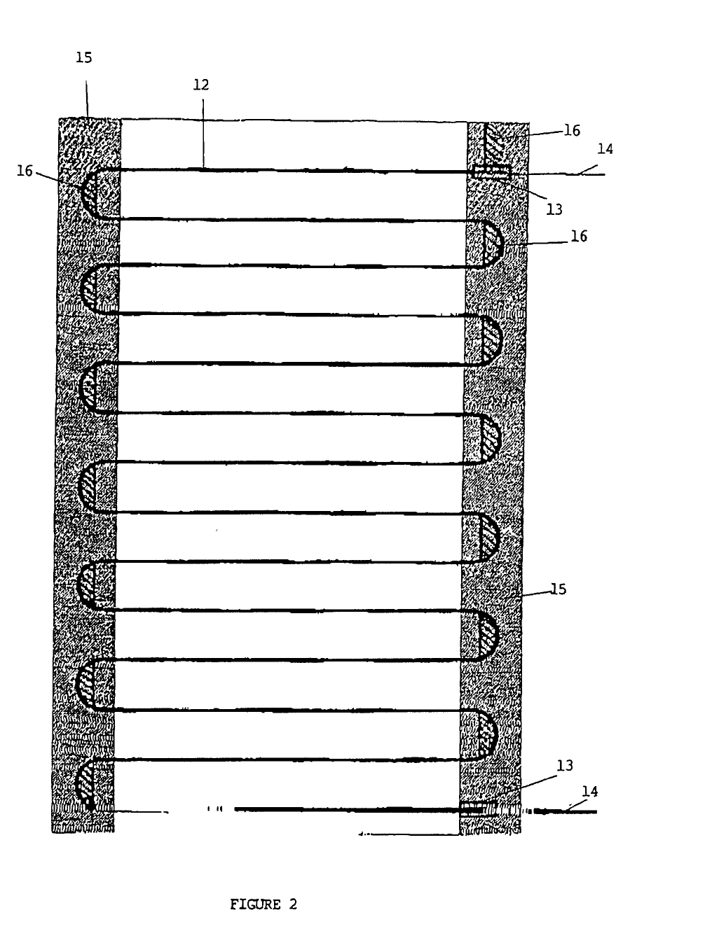

In FIG. 2, the heating element 12 is shown upon a jig that comprises a pair of arms 15, each having a linear array of curved lugs 16. The continuous element 12 is passed back and forth between the arms 15 about the lugs 16.

In order to fabricate the heating pad 10, each plastics sheet 11 is brought to one side of the parallel, straight portions of the heating element 12 and adhered to one another to thereby maintain the spaced relationship between the respective parallel portions. The curved ends of the heating element are then detached from the lines 16 of the jig arms 15. Either before or after this detachment, the lead wires 14 are crimped using metallic crimping plates or crimping cylinders 13 to the respective ends of the heating element 12.

The remaining portions of the plastics sheets 11 are then pressed against one another to thereby encase the curved end portions of the heating element 12, the crimped metallic piece 13 and the end portions of the two lead wires. As the lead wires 14 are insulated, the finished heating pad is fully-insulated.

The filaments of the carbon fibre heating element 12 are very fine, like hair, or even finer, but the overall thickness of the element might be about 1 mm. When the plastics sheets 11 are pressed against one another, the element 12 might flatten slightly as the bundle of fibres is compressed. In this regard, it should be appreciated that the fibres extend parallel to one another and are not twisted like the copper conductors of an electrical multi-strand conductor. This enables the strands to spread out when the plastics sheets are pressed together to thereby provide a less protrusive element and a more comfortable heating pad.

One or both of the insulative plastics sheets 11 might be pre-glued on one side. Alternatively, heat might be applied to melt the two sheets together with the element 12 therebetween.

A layer of soft padding can be provided on each side of the heating pad and a further outer layer can be provided over the padding.

It should be appreciated that modifications and alterations obvious to those skilled in the art are not to be considered as beyond the scope of the present invention. Furthermore, alternative uses of the heating pad can be performed without departing from the present invention. For example, clothing could be made having the heating pad formed therein. Also, instead of using a multi-filament non-twisted carbon fibre heating element, a flat ribbon-like carbon film could be used. Furthermore, instead of a providing the heating element in a serpentine form, defeating element could take on any other convenient configuration such as a coil form.

1. A heating pad comprising:
a multi-filament carbon fibre heating element, or a flat carbon film heating element, and
a pair of sheets adhered to one another with the heating element held in position therebetween by the sheets.

2. The heating pad of claim 1, wherein the heating element is configured in a serpentine form.

3. The heating pad of claim 1, wherein each end of the heating element is attached by a crimp plate to a lead wire.

4. The heating pad of claim 1, further comprising a soft padding layer at each side thereof.

5. The heating pad of claim 4, wherein each soft padding layer is covered with an outer-layer.

6. The heating pad of claim 1, wherein a multi-filament heating element is employed and the filaments extent substantially parallel to one another without twisting.

7. A method of manufacturing a heating pad, the method comprising:
providing a jig having a pair of opposed arms each with an array of lugs,
extending a non-insulated carbon heating element back and forth between the arms and once-engaging each lug in a serpentine form,
applying a pair of insulative sheets to each side of the element so as to encase a substantial portion thereof,
adhering the sheets to one another so as to permanently locate the heating element therebetween, and
removing the sheets and elements from the jig.

8. The method of claim 7, further comprises:
crimping a metallic-conductor lead wire to each respective end of the heating element, and
adhering the remaining portions of the sheets to one another to thereby encase the ends of the element therebetween.

9. The method of claim 7, wherein the heating element is a multi-fibre, non-twisted element.

10. The method of claim 7, wherein the heating element is a flat carbon film.
